(19) United States
(12) Patent Application Publication
(10) Pub. No.: US 2026/0177311 A1
(43) Pub. Date: Jun. 25, 2026

(54) REFRIGERATOR

(71) Applicant: LG Electronics Inc., Seoul (KR)

(72) Inventors: Jongmoon JANG, Seoul (KR); Jawon KOO, Seoul (KR); Jungmi KIM, Seoul (KR)

(21) Appl. No.: 19/394,351

(22) Filed: Nov. 19, 2025

(30) Foreign Application Priority Data
Dec. 24, 2024 (KR) 10-2024-0196050

(51) Int. Cl. F25D 27/00; F25D 23/06

(52) U.S. Cl. CPC F25D 27/00; F25D 23/062

(57) ABSTRACT

A refrigerator includes a cabinet forming a storage compartment; a lighting assembly disposed at an inner upper part of the storage compartment and providing light toward the storage compartment; and a duct assembly disposed at an inner rear part of the storage compartment, in which the lighting assembly includes a lighting device having a rear end which is supported by the duct assembly and a front end which is fixed to the cabinet.

### CROSS-REFERENCE TO RELATED APPLICATIONS

This application claims the benefit of Korean Patent Application No 10-2024-0196050, filed on Dec. 24, 2024. The disclosure of the prior application is incorporated by reference in its entirety.

### BACKGROUND

The present disclosure relates to a refrigerator.

A refrigerator is a home appliance that supplies cold air generated by the circulation of refrigerant to a storage compartment, thereby keeping various types of stored items fresh for a long period of time.

The storage compartment of the refrigerator is equipped with lighting so that the user can easily check the contents inside when opening the door. For example, the lighting installed in the storage compartment can be installed in a certain area on the side of the storage compartment to illuminate the inside of the storage compartment.

However, if installed in a certain area of the side of the storage compartment like this, it is difficult to evenly illuminate the entire area of the storage compartment, and there may be a problem that the lighting is obscured by the stored items inside.

Accordingly, a lighting device in the form of a surface light having a large area that can illuminate the entire front surface of the storage compartment can be installed inside the storage compartment. In this way, when surface lights are installed inside the storage compartment, there is also an advantage in that not only can it illuminate the entire area of the storage compartment as evenly as possible, it can also illuminate the interior of the storage regardless of the location of the stored items inside.

However, in the case of a lighting device in the form of a surface light installed at the rear surface of a storage compartment, a lighting device's coupling structure with strong fixing power that can withstand the weight of the lighting device itself may be required. In addition, due to the characteristics of the surface light that requires minimizing the coupling structure in the central area, a sagging phenomenon may occur in the central area.

Therefore, a coupling structure of a lighting device may be required that can reduce the occurrence of distortion of a bezel that forms and supports the outer appearance of the lighting device and reinforce strength to reduce sagging of the lighting device.

### SUMMARY

An object of an embodiment of the present disclosure is to provide a refrigerator having a structure in which a surface lighting device is stably mounted on the upper surface of a storage compartment.

An object of an embodiment of the present disclosure is to provide a refrigerator capable of preventing movement of a surface lighting device.

An object of an embodiment of the present disclosure is to provide a user with improved aesthetics regarding the design finish of a surface light by means of a cover member that shields the front part of the surface light.

An object of an embodiment of the present disclosure is to simplify the manufacturing process of a refrigerator through a structure in which a surface lighting device can be easily mounted on the upper surface of a storage compartment.

According to one embodiment to solve the above problem, a refrigerator includes a cabinet forming a storage compartment; a lighting assembly disposed at an inner upper part of the storage compartment and providing light toward the storage compartment; and a duct assembly disposed at an inner rear part of the storage compartment, in which the lighting assembly includes a lighting device having a rear end which is supported by the duct assembly and a front end which is fixed to the cabinet.

The lighting device may include a light guide assembly in the shape of a flat plate, a light source part irradiating light toward one side of the light guide assembly, and a coupling member coupled along a perimeter of the light guide assembly.

The coupling member may include a rear coupling member coupled to a rear end part of the light guide assembly and supported by the duct assembly, and a front coupling member coupled to a front end part of the light guide assembly and fixed to the cabinet.

The lighting assembly may further include a cover member that is mounted on the front coupling member and shields the front end of the lighting device.

The front coupling member may include a front base part that extends in the extension direction of the front end part of the light guide assembly and faces an upper surface of the front end part of the light guide assembly, a front extension part that extends downward from one surface of the front base part and faces a side surface and a lower surface of the front end part of the light guide assembly, and a front restraint part that is formed by protruding downward from a front end of the front base part.

The cover member may include a cover base part extending in an extension direction of the front base part, a cover front part bent upward from a front end of the cover base part, and a cover coupling part formed by protruding upward from one surface of the cover base part, and the cover coupling part may be hooked and coupled to the front restraint part.

The front base part may be fixed to the cabinet through a fastening part and includes a fastening hole through which the fastening part penetrates, and the cover coupling part may extend in the extension direction of the cover base part and includes a cut-out formed at a position corresponding to the fastening hole.

The coupling member further include a side coupling member coupled to both side end parts of the light guide assembly, and a rear end part of the side coupling member may be fitted to both end parts of the rear coupling member.

The front coupling member may form a space in which the light source part is accommodated.

The front coupling member may be fixed to the cabinet through a fastening part.

The refrigerator may further include a shelf provided inside the storage compartment; and a shelf mounting member on which the shelf is detachably mounted and which is provided on one side and the other side of the duct assembly, the lighting assembly may further include a supporting member supporting both side ends of the lighting device, a rear end of the supporting member may be supported by an upper end of the shelf mounting member, and a front end of the supporting member may be fixed to the cabinet.

The support member may include a support base part extending in an extension direction of the side end part of the lighting device, and a support hook part formed at a rear end of the support base part and hooked and coupled to the upper end of the shelf mounting member.

The support member may further include a support side part that extends upwardly from the inner end part of the support base part and supports both side ends of the lighting device, and a support fastening part that extends inwardly from an upper end of the support side part and is fixed to the cabinet.

The support fastening part may be disposed spaced apart from the lighting device in a vertical direction.

The support member may be formed by protruding inwardly from the support base part, and further include a support rib that supports both side ends of the lighting device.

The lighting device may include a flat-plate shaped light guide assembly, a front coupling member coupled to a front end of the light guide assembly, the support member may further include a support protrusion formed on the inner surface of the support side part and protruding toward the front coupling member, and the front coupling member may include a front mounting groove in which the support protrusion is disposed.

The duct assembly may include a duct plate including a duct front part defining a rear surface of the storage compartment, and a duct upper part including a cold air discharge port through which cold air is discharged, and a duct guide part disposed on an upper part of the duct plate and guiding cold air discharged from the cold air discharge port to be discharged toward the storage compartment, and the rear end of the lighting device may be supported by the duct guide part.

The duct guide part may include a guide base part that is disposed on an upper part of the duct upper surface and is disposed toward the storage compartment, a guide round part that is connected to the lower end part of the guide base part and is rounded downward as it goes toward the rear, and a guide support part that is disposed on both side end parts of the guide base part, and the rear end of the lighting device may be supported by the guide support part.

The lighting device may include a flat plate-shaped light guide assembly, and a rear coupling member coupled to a rear end of the light guide assembly, and the guide support part may support both side end parts of the rear coupling member.

The cabinet may include an inner case forming the storage compartment, an outer case forming an outer appearance and disposed on the outside of the inner case, and an insulation material disposed between the inner case and the outer case, and the front end of the lighting device may be fixed to the upper part of the inner case forming the upper surface of the storage compartment.

According to an embodiment of the present disclosure, the surface lighting device can be stably mounted on the upper surface of a storage compartment by coupling the surface lighting device with the inner case and the duct assembly.

According to an embodiment of the present disclosure, movement of the surface lighting device can be prevented through a support member provided around the surface lighting device.

According to an embodiment of the present disclosure, an improved aesthetic sense of design finish of the surface light can be provided to the user through a cover member that shields the front surface of the surface light device.

According to an embodiment of the present disclosure, the manufacturing process of a refrigerator can be simplified through a structure in which a surface lighting device can be easily mounted on the upper surface of a storage compartment.

### BRIEF DESCRIPTION OF THE DRAWINGS

FIG. 1 is a front view illustrating a refrigerator according to one embodiment.

FIG. 2 is a view illustrating a state where a door of a refrigerator is open according to one embodiment.

FIG. 3 is a perspective view illustrating an inner case of a refrigerator and an internal structure of the inner case according to one embodiment.

FIG. 4 is a perspective view illustrating a storage compartment assembly disposed in a first storage compartment of a refrigerator according to one embodiment.

FIG. 5 is an exploded perspective view illustrating the coupling relationship between the upper lighting assembly and the duct assembly of the refrigerator according to one embodiment.

FIG. 6 is a perspective view illustrating the upper lighting assembly according to one embodiment.

FIG. 7 is an exploded perspective view illustrating the upper lighting assembly according to one embodiment.

FIG. 8 is a perspective view illustrating a duct member according to one embodiment.

FIG. 9 is a cross-sectional perspective view taken along line 9-9 of FIG. 3.

FIGS. 10 and 11 are perspective views illustrating a support member according to one embodiment.

FIG. 12 is a perspective view illustrating a cover member according to one embodiment.

FIGS. 13 and 14 are perspective views illustrating a shelf mounting member according to one embodiment.

FIG. 15 is a cross-sectional view taken along line 15-15 of FIG. 9.

FIG. 16 is a cross-sectional perspective view taken along line 16-16 of FIG. 9.

FIG. 17 is a cross-sectional view taken along line 16-16 of FIG. 9.

FIG. 18 is a cross-sectional view taken along line 18-18 of FIG. 9.

FIG. 19 is a cross-sectional view taken along line 19-19 of FIG. 9.

FIG. 20 is a cross-sectional view taken along line 20-20 of FIG. 9.

FIGS. 21 and 22 are perspective views illustrating enlarged views of area A of FIG. 9.

FIG. 23 is a cross-sectional view taken along line 18-18 of FIG. 9 of a refrigerator according to another embodiment.

### DETAILED DESCRIPTION

Hereinafter, specific embodiments of the present disclosure will be described in detail with reference to the drawings. However, the present disclosure is not limited to the embodiments in which the idea of the present disclosure is presented, and other regressive disclosures or other embodiments included within the scope of the idea of the present disclosure can be easily proposed by adding, changing, deleting, or the like other components.

In order to clearly and briefly explain the present disclosure, parts irrelevant to the description are omitted in the drawings, and the same drawing reference numerals are used for identical or extremely similar parts throughout the specification.

The suffixes “module” and “part” used for components in the following description are given simply for the convenience of writing this specification, and do not in themselves impart any particularly important meaning or role. Accordingly, the above “module” and “part” may be used interchangeably.

In this specification, it should be understood that the terms “comprises” or “has” and the like are intended to specify the presence of a feature, number, step, operation, component, part, or combination thereof described in the specification, but do not exclude in advance the possibility of the presence or addition of one or more other features, numbers, steps, operations, components, parts, or combinations thereof.

Additionally, in this specification, terms such as first, second, or the like may be used to describe various elements, but these elements are not limited by these terms. These terms are only used to distinguish one element from another.

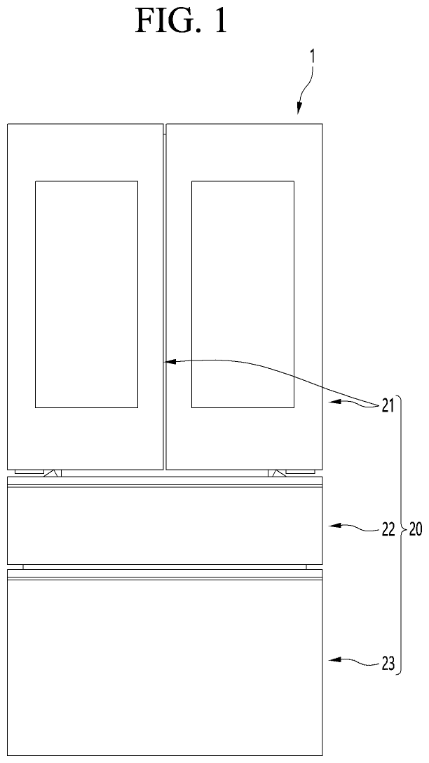

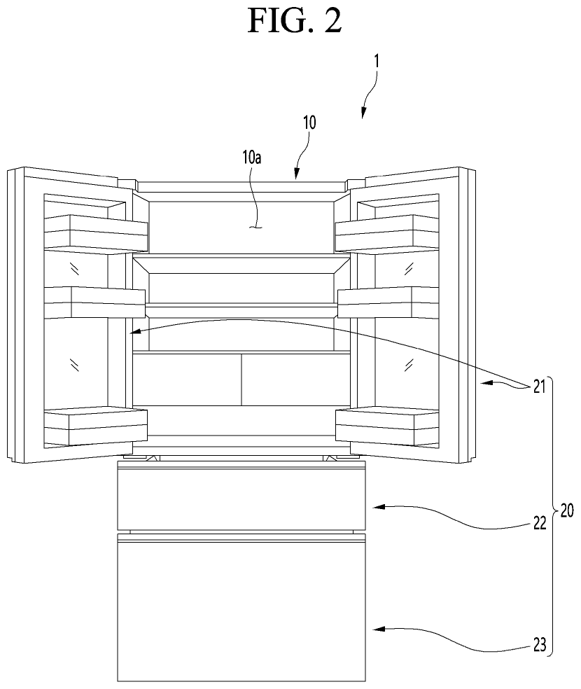

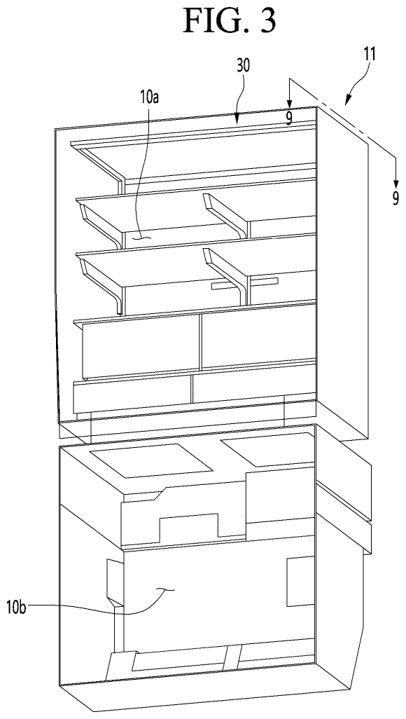

FIG. 1 is a front view illustrating a refrigerator according to one embodiment. FIG. 2 is a view illustrating a state where a door of a refrigerator is open according to one embodiment. FIG. 3 is a perspective view illustrating an inner case of a refrigerator and an internal structure of the inner case according to one embodiment.

Referring to FIGS. 1 to 3, a refrigerator 1 according to one embodiment may have an outer appearance formed by a cabinet 10 including one or more storage compartments 10a, 10b and one or more doors 20 configured to open and close an open front surface of the cabinet 10.

The cabinet 10 may include an outer case (not illustrated) forming the outer appearance of the refrigerator 1 and an inner case 11 forming the inner surface. Although not illustrated, an insulation space filled with an insulation material may be formed between the outer case (not illustrated) and the inner case 11.

The cabinet 10 may include one or more storage compartments 10a, 10b. For example, the cabinet 10 may be divided by a barrier and include a first storage compartment 10a positioned above the barrier and a second storage compartment 10b positioned below the barrier. For example, the first storage compartment 10a positioned above may be a refrigerating compartment, and the second storage compartment 10b positioned below may be a freezing compartment.

The vertical direction, left and right direction, and front and rear direction described in this specification can be described based on the direction when a user using the refrigerator 1 looks at the front surface of the refrigerator 1. At this time, the front of the refrigerator 1 can mean a direction closer to the user, and the rear of the refrigerator 1 can mean a direction away from the direction in which the user is located.

In a refrigerator 1 according to one embodiment, the door 20 may include a first door 21 configured to open and close a first storage compartment 10a, and a second door 22 and a third door 23 configured to open and close a second storage compartment 10b. As an example, the first door 21 may be referred to as a refrigerating compartment door, and the second door 22 and the third door 23 may be referred to as freezing compartment doors.

The first door 21 may be configured to be rotatably coupled to the cabinet 10 to open and close the first storage compartment 10a. For example, the first door 21 may be provided as a pair of doors disposed in the left and right direction. In other words, the first door 21 may include a left door configured to open and close a left part of the first storage compartment 10a, and a right door configured to open and close a right part of the first storage compartment 10a.

The second door 22 and the third door 23 may be configured to open and close the second storage compartment 10b in a sliding manner. In other words, the second door 22 and the third door 23 may be provided as drawer doors that can be moved in a sliding manner with respect to the cabinet 10. For example, the second door 22 may be disposed at the lower part of the first door 21, and the third door 23 may be disposed at the lower part of the second door 22.

In the refrigerator 1 according to one embodiment, the door 20 for opening and closing the second storage compartment 10b has been described based on the second door 22 and the third door 23 formed as drawer doors, but is not limited thereto, and the door 20 for opening and closing the second storage compartment 10b may be provided in various forms. For example, the door 20 for opening and closing the second storage compartment 10b may be provided as a door 20 rotatably coupled to the cabinet 10 like the first door 21, or may be provided as a single door 20 in the form of a drawer door that slides with respect to the cabinet 10.

Meanwhile, a refrigerator 1 according to one embodiment may include a storage compartment assembly 30 provided in a first storage compartment 10a. The storage compartment assembly 30 is a set of components disposed inside the first storage compartment 10a and may form an internal structure of the first storage compartment 10a.

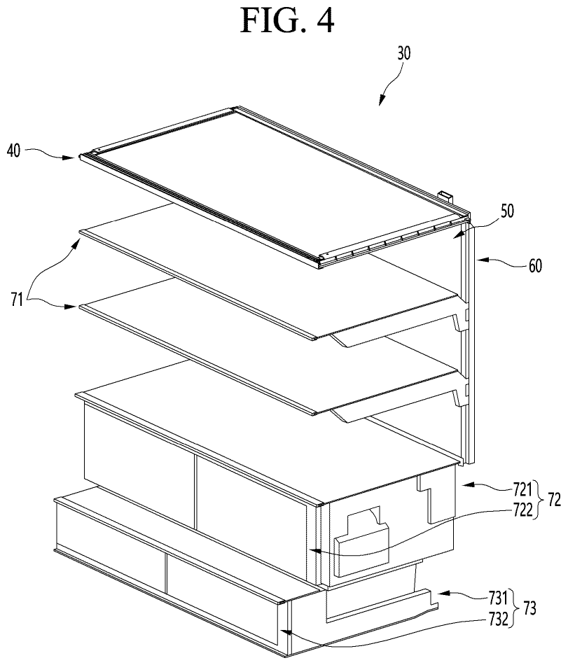

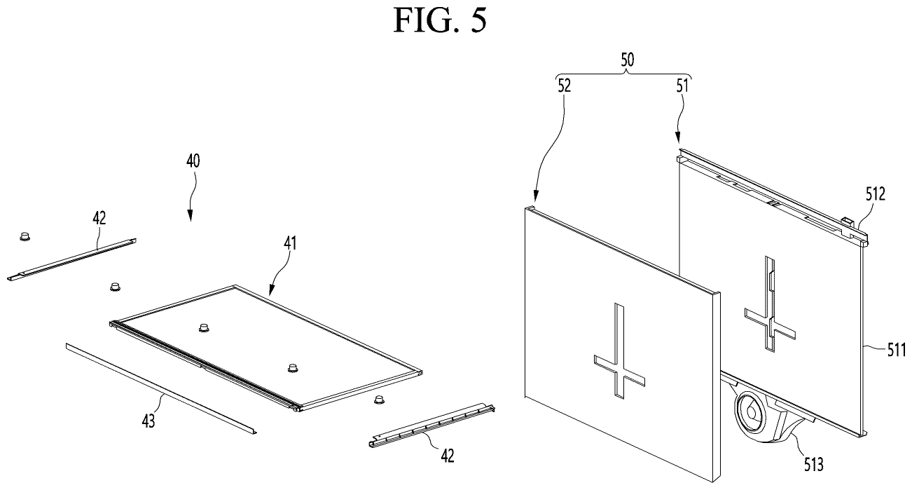

The storage compartment assembly 30 will be described with reference to FIGS. 4 and 5.

FIG. 4 is a perspective view illustrating a storage compartment assembly disposed in a first storage compartment of a refrigerator according to one embodiment. FIG. 5 is an exploded perspective view illustrating the coupling relationship between the upper lighting assembly and the duct assembly of the refrigerator according to one embodiment.

Referring to FIGS. 4 and 5, a storage compartment assembly 30 disposed in a first storage compartment 10a of a refrigerator 1 according to one embodiment may include an upper lighting assembly 40 disposed on an upper surface of the first storage compartment 10a and a duct assembly 50 disposed on a rear surface of the first storage compartment 10a.

The upper lighting assembly 40 is disposed on the upper surface of the first storage compartment 10a and can illuminate the first storage compartment 10a from the upper side to the lower side. For example, the upper lighting assembly 40 can be provided in the form of a surface light. Accordingly, the upper lighting assembly 40 can provide light over the entire area of the first storage compartment 10a.

The upper lighting assembly 40 can be turned on in various situations to illuminate the first storage compartment 10a. For example, when the door 20 is opened, the upper lighting assembly 40 can be turned on to illuminate the first storage compartment 10a. In addition, when an on signal is detected by a touch sensor (not illustrated) for operating the upper lighting assembly 40, when an on signal is detected by a knock detection sensor (not illustrated) for detecting a knock on the door 20, or when a user's approach is detected through a proximity detection sensor (not illustrated), the upper lighting assembly 40 can be turned on to illuminate the first storage compartment 10a.

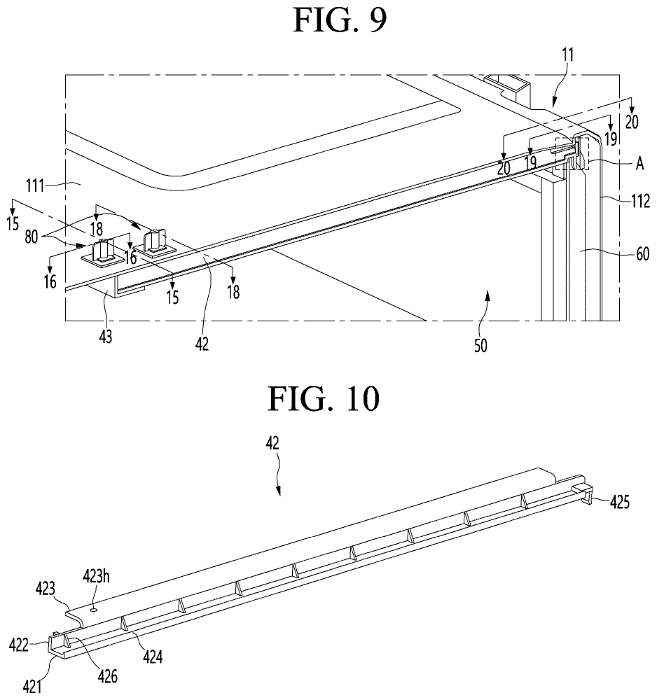

Meanwhile, the front end of the upper lighting assembly 40 can be fixed to the upper part ‘111’ (FIG. 9) of the inner case 11, and the rear end can be fixed to the duct assembly 50.

The upper lighting assembly 40 may include a lighting device 41 that provides light, a support member 42 and a cover member 43 disposed around the lighting device 41. For example, the support members 42 may be provided as a pair and disposed on both sides of the lighting device 41. Additionally, the cover member 43 may cover the front surface of the lighting device 41.

The lighting device 41 may be configured to provide light in the upper lighting assembly 40. The lighting device 41 may be formed as a surface light. The lighting device 41 may be provided in a flat shape. The lighting device 41 may provide light in a direction intersecting one side.

The lighting device 41 may be positioned so as to be parallel to the upper surface of the first storage compartment 10a. Accordingly, the lighting device 41 may provide light in a downward direction from the upper surface of the first storage compartment 10a. As will be described later, the rear end of the lighting device 41 may be supported by a duct member 51, and the front end thereof may be fixed to the upper part 111 of the inner case 11.

The support member 42 may be provided as a pair. The support member 42 may have a shape extending in the front and rear direction. The support member 42 may extend along both ends of the lighting device 41. For example, the length of the support member 42 may correspond to the length of both ends of the lighting device 41.

A pair of support members 42 can be disposed on one side and the other side of the lighting device 41, respectively. A pair of support members 42 can support both sides of the lighting device 41. The support members 42 can be disposed between the lighting device 41 and the inner case 11. Therefore, the support members 42 can prevent left-right movement of the lighting device 41.

The rear end of the support member 42 can be hooked to a shelf mounting member 60 described later, and the front end thereof can be fixed to the upper part 111 of the inner case 11.

The cover member 43 may be placed in front of the lighting device 41. The cover member 43 may have a shape extending in the left and right direction. The cover member 43 may extend along the front end of the lighting device 41. For example, the length of the cover member 43 may correspond to the length of the front end of the lighting device 41.

The cover member 43 can shield the front surface of the lighting device 41. Through this, the cover member 43 can prevent the front exposure of the lighting device 41. In other words, the lighting device 41 can not be seen from the front by the cover member 43. The cover member 43 can be mounted and fixed to the front end of the lighting device 41.

In a refrigerator 1 according to one embodiment, a duct assembly 50 may include a duct member 51 forming a cold air flow path and a rear lighting assembly 52 disposed in front of the duct member 51. The duct assembly 50 may form the rear surface of the first storage compartment 10a. The duct assembly 50 may support the rear end of the lighting device 41.

The duct member 51 can form a flow path for cold air to be supplied to the first storage compartment 10a. The duct member 51 can include a duct plate part 511, a duct guide part 512 disposed on the upper side of the duct plate part 511, and a duct fan 513 disposed on the lower side of the duct plate part 511.

The duct plate part 511 can form a flow path for cold air supplied from the evaporator to the first storage compartment 10a. The duct plate part 511 can have a rectangular flat plate shape. The duct plate part 511 can be disposed at the rear of the first storage compartment 10a. Cold air moving through the duct plate part 511 can be discharged to the first storage compartment 10a through the duct guide part 512.

The duct guide part 512 can form the upper end of the duct member 51. The duct guide part 512 can extend in the left and right directions along the upper end of the duct plate part 511. As described above, the duct guide part 512 can discharge cold air flowing along the duct plate part 511 to the first storage compartment 10a. As will be described later, the duct guide part 512 can support the rear end of the lighting device 41 upward.

The duct fan 513 may be placed at the lower part of the duct plate part 511. The duct fan 513 may flow cold air toward the duct plate part 511 by rotating. As an example, the duct fan 513 may be placed at the rear of the first drawer assembly 72 described below.

A rear lighting assembly 52 may be placed in front of the duct member 51.

The rear lighting assembly 52 is disposed at the rear surface of the first storage compartment 10a and can illuminate the first storage compartment 10a from the rear toward the front. The rear lighting assembly 52 can form the rear surface of the first storage compartment 10a.

The rear lighting assembly 52 may have substantially the same structure as the upper lighting assembly 40 in terms of the lighting method. For example, the rear lighting assembly 52 may include a lighting device formed as a surface lighting. In other words, the rear lighting assembly 52 is provided in the form of a surface light and may provide light over the entire area of the first storage compartment 10a. The refrigerator 1 according to one embodiment may efficiently illuminate the first storage compartment 10a through the rear lighting assembly 52 disposed at the rear of the first storage compartment 10a and the upper lighting assembly 40 disposed above.

Meanwhile, the rear lighting assembly 52 may be mounted on the duct member 51. However, it is not limited thereto, and the rear lighting assembly 52 may be mounted on the inner case 11 or mounted and fixed on another configuration of the storage compartment assembly 30.

The rear lighting assembly 52 may shield the front surface of the duct plate part 511 of the duct member 51, but may not shield the duct guide part 512. Through the above structure, the rear lighting assembly 52 may not obstruct the flow of cold air discharged from the duct guide part 512 to the first storage compartment 10a.

Meanwhile, the storage compartment assembly 30 of the refrigerator 1 according to one embodiment may further include shelf mounting members 60 disposed on both sides of the duct assembly 50. The shelf mounting members 60 may be coupled to both side ends of the duct assembly 50. The shelf mounting members 60 may have a shape extending in the vertical direction. The length of the shelf mounting members 60 may correspond to the lengths of both side ends of the duct plate part 511.

The shelf mounting member 60 may be provided to support a shelf member 71 described later. For example, a shelf member 71 may be detachably coupled to the shelf mounting member 60.

Meanwhile, the rear end of the support member 42 can be hooked to the upper end of the shelf mounting member 60. The upper end of the shelf mounting member 60 can support the rear end of the support member 42. In other words, since the upper end of the shelf mounting member 60 supports the rear end of the support member 42 while the shelf mounting member 60 is fixed to the duct assembly 50, the rear end of the support member 42 can be stably supported.

Additionally, the storage compartment assembly 30 of the refrigerator 1 according to one embodiment may further include a plurality of shelf members 71 and a plurality of drawer assemblies 72, 73.

A plurality of shelf members 71 may include shelf members 71. The shelf members 71 may be spaced apart and disposed at the lower part of the upper lighting assembly 40. A storage item to be stored in the first storage compartment 10a may be disposed on the shelf members 71. The shelf members 71 may be provided in a flat shape parallel to the upper lighting assembly 40.

A plurality of shelf members 71 may be provided. A plurality of shelf members 71 may be disposed spaced apart from each other in the vertical direction. A plurality of shelf members 71 may be detachably mounted on a shelf mounting member 60.

The plurality of drawer assemblies 72, 73 may include a first drawer assembly 72 positioned below the shelf member 71, and a second drawer assembly 73 positioned below the first drawer assembly 72.

The first drawer assembly 72 may include a first case part 721 that is disposed at the lower part of the shelf member 71 and forms a storage space, and a first drawer part 722 that is provided to be drawn in and out of the first case part 721. As described above, a duct fan 513 may be disposed at the rear of the first drawer assembly 72.

The second drawer assembly 73 may include a second case part 731 that is positioned at the lower part of the first drawer assembly 72 and forms a storage space, and a second drawer part 732 that is provided to be drawn in and out of the second case part 731. For example, the front end of the second drawer assembly 73 may be positioned forward of the front end of the first drawer assembly 72.

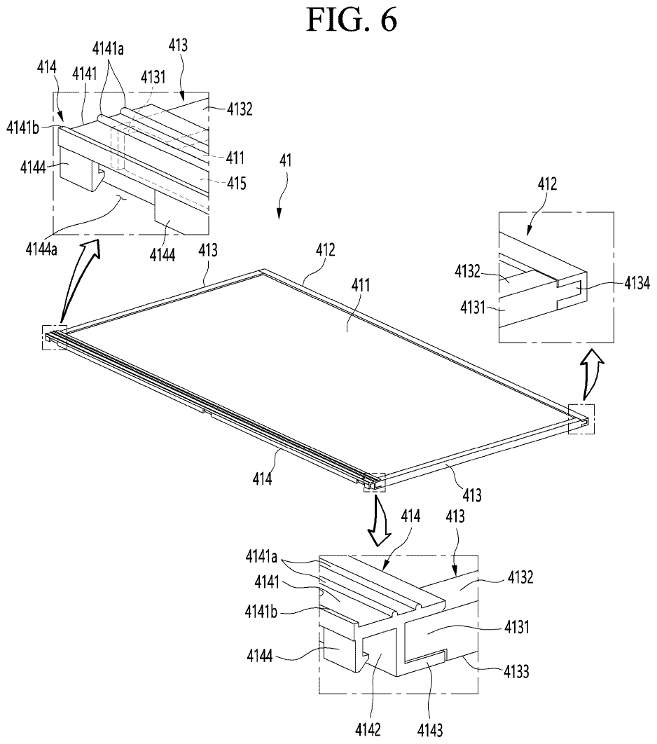

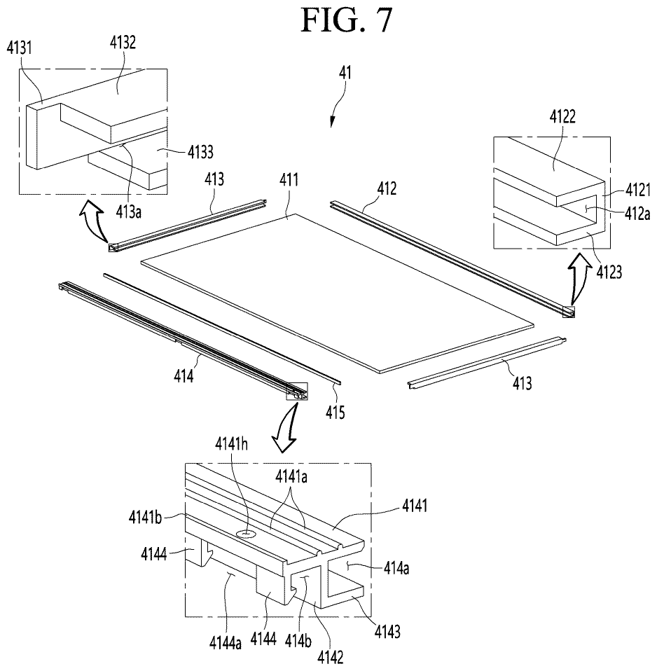

Below, the detailed structure of the lighting device 41 will be described with reference to FIGS. 6 and 7.

FIG. 6 is a perspective view illustrating the upper lighting assembly according to one embodiment. FIG. 7 is an exploded perspective view illustrating the upper lighting assembly according to one embodiment.

Referring to FIGS. 6 and 7, a lighting device 41 of an upper lighting assembly 40 included in a refrigerator 1 according to one embodiment may include a light guide assembly 411, a light source part 415 that irradiates light toward the light guide assembly 411, and coupling members 412, 413, 414 disposed around the light guide assembly 411.

The light guide assembly 411 can disperse light provided from the light source part 415. The light guide assembly 411 can have a flat shape. In other words, the light guide assembly 411 can disperse light provided from the light source part 415 to configure the lighting device 41 as a surface lighting. The light guide assembly 411 can provide light in a direction intersecting one side of the flat shape.

A light source part 415 may be disposed in front of the light guide assembly 411. The light source part 415 may extend in a direction corresponding to the front end part of the light guide assembly 411 that extends in the left and right direction. For example, the light source part 415 may be formed as a linear light source. The light source part 415 irradiates light toward the front end part of the light guide assembly 411, and the light guide assembly 411 that receives light from the light source part 415 may provide light toward one surface. In other words, the light guide assembly 411 may convert a linear light source into a surface light source.

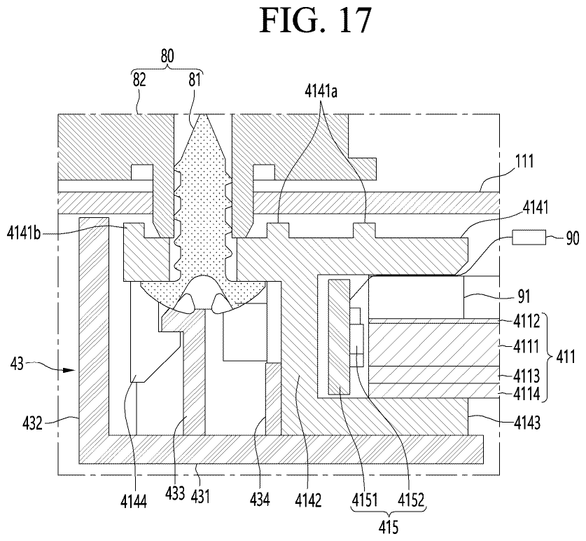

The detailed structure of the light guiding assembly 411 and the light source part 415 will be described later with reference to FIGS. 16 and 17.

A coupling member 412, 413, 414 may be disposed around the light guide assembly 411. The coupling member 412, 413, 414 may be disposed to surround the light guide assembly 411. At least a part of the light guide assembly 411 may be inserted into and coupled to the coupling member 412, 413, 414.

The coupling members 412, 413, 414 may include a rear coupling member 412 coupled to the rear end part of the light guide assembly 411, a side coupling member 413 coupled to the side end part of the light guide assembly 411, and a front coupling member 414 coupled to the front end part of the light guide assembly 411.

The rear coupling member 412 may have a shape extending along the rear end part of the light guide assembly 411. For example, the rear coupling member 412 may extend in the left and right direction.

The rear coupling member 412 may include a rear base part 4121 facing the rear end part of the light guide assembly 411, a first rear extension part 4122 extending forward from one side of the rear base part 4121, and a second rear extension part 4123 extending forward from the other side of the rear base part 4121.

For example, the first rear extension part 4122 may extend forward from the upper end of the rear base part 4121, and the second rear extension 4122 may extend forward from the lower end of the rear base part 4121.

The rear coupling member 412 may include a rear coupling groove 412a defined by a rear base part 4121, a first rear extension part 4122, and a second rear extension part 4123. The rear end part of the light guide assembly 411 may be inserted into the rear coupling groove 412a. In a state where the rear end part of the light guide assembly 411 is inserted into the rear coupling groove 412a, the rear base part 4121 may support the rear surface of the rear end part of the light guide assembly 411, the first rear extension part 4122 may support the upper surface of the rear end part of the light guide assembly 411, and the second rear extension part 4123 may support the lower surface of the rear end part of the light guide assembly 411.

A pair of side coupling members 413 may be provided. For example, a pair of side coupling members 413 may be respectively disposed on one side and the other side of the light guide assembly 411. Hereinafter, a detailed structure of the side coupling members 413 will be described based on one of the pair of side coupling members 413.

The side coupling member 413 may have a shape that extends along the side end part of the light guide assembly 411. For example, the side coupling member 413 may extend in the front and rear direction. The side coupling member 413 may include a side base part 4131 facing the side end part of the light guide assembly 411, a first side extension part 4132 that extends laterally from one side of the side base part 4131, and a second side extension part 4133 that extends laterally from the other side of the side base part 4131.

For example, the first side extension part 4132 may extend laterally from the upper end of the side base part 4131, and the second side extension part 4132 may extend laterally from the lower end of the side base part 4131.

The side coupling member 413 may include a side coupling groove 413a defined by a side base part 4131, a first side extension part 4132, and a second side extension part 4133. A side end part of the light guide assembly 411 may be inserted into the side coupling groove 413a. In a state where the side end part of the light guide assembly 411 is inserted into the side coupling groove 413a, the side base part 4131 may support a side surface of the side end part of the light guide assembly 411, the first side extension part 4132 may support an upper surface of the side end part of the light guide assembly 411, and the second side extension part 4133 may support a lower surface of the side end part of the light guide assembly 411.

For example, the front end of the first side extension part 4132 may be formed to protrude forward more than the front end of the second side extension part 4133. Additionally, the front end of the side base part 4131 may be formed to protrude forward more than the front end of the first side extension part 4132.

Meanwhile, the side coupling member 413 may further include a side protrusion part 4134 that protrudes rearwardly from the rear end of the side base part 4131. For example, the side protrusion part 4134 may be formed by partially protruding the central part of the side base part 4131 rearwardly. The side protrusion part 4134 may be inserted into the rear coupling groove 412a of the rear coupling member 412. The side protrusion part 4134 may be configured in a shape corresponding to the rear coupling groove 412a. In other words, through the coupled structure of the side protrusion part 4134 and the rear coupling groove 412a, the side coupling member 413 and the rear coupling member 412 may be mutually coupled.

The front coupling member 414 may have a shape extending along the front end part of the light guide assembly 411. For example, the front coupling member 414 may extend in the left and right direction.

The front coupling member 414 may include a front base part 4141 facing the upper surface of the front end part of the light guide assembly 411, a first front extension part 4142 extending downward from one surface of the front base part 4141, a second front extension part 4143 extending rearward from an end part of the first front extension part 4142, and a front restraint part 4144 formed by protruding downward from the front end of the front base part 4141.

The front base part 4141 can support the upper surface of the front end part of the light guide assembly 411. The front base part 4141 can have a shape extending in the left and right direction according to the shape of the front end part of the light guide assembly 411. The front base part 4141 can extend from the upper surface of the front end part of the light guide assembly 411 toward the outside of the light guide assembly 411. In other words, at least a part of the front base part 4141 can be disposed to overlap with the light guide assembly 411, but not to overlap with the light guide assembly 411.

A plurality of front ribs 4141a, 4141b protruding upward may be formed on the front base part 4141. The front ribs 4141a, 4141b can prevent the front base part 4141 from being structurally deformed when the front coupling member 414 is fixed to the upper part 111 of the inner case 11.

The front ribs 4141a, 4141b may have a shape extending along the extension direction of the front base part 4141. For example, the front ribs 4141a, 4141b may include a first front rib 4141a disposed on one surface of the front base part 4141 and a second front rib 4141b disposed at a front end part of the front base part 4141.

The front base part 4141 may include an open front fastening hole 4141h. For example, a fastening member for fastening the front coupling member 414 to the upper part 111 of the inner case 11 may be inserted into the front fastening hole 4141h. The front fastening hole 4141h may be disposed between the first front rib 4141a and the second front rib 4141b.

The first front extension part 4142 may have a shape extending downward from the lower surface of the front base part 4141. The first front extension part 4142 may extend in the same direction as the extension direction of the front base part 4141. For example, the first front extension part 4142 may be disposed facing the front surface of the light guide assembly 411. The first front extension part 4142 may support the front surface of the light guide assembly 411.

The second front extension part 4143 can extend from the lower end part of the first front extension part 4142 toward the light guide assembly 411. The second front extension part 4142 can be positioned facing the lower surface of the front end part of the light guide assembly 411. The second front extension part 4142 can support the lower surface of the front end part of the light guide assembly 411.

The second front extension part 4143 can support the side base part 4131. For example, both end parts of the second front extension part 4143 can support the front end of the side base part 4131. In other words, the front end of the side base part 4131 can be supported by being seated on the second front extension part 4143. Through the above structure, the front end of the side coupling member 413 can be supported by the front coupling member 414.

The front coupling member 414 may include a front coupling groove 414a defined by a front base part 4141, a first front extension part 4142, and a second front extension part 4143. The front coupling groove 414a may be defined by a lower surface of the front base part 4141, a rear surface of the first front extension part 4142, and an upper surface of the second front extension part 4143.

The front end part of the light guide assembly 411 can be inserted into the front coupling groove 414a. The front coupling groove 414a can have a shape corresponding to the front end part of the light guide assembly 411.

In addition, a light source part 415 may be disposed in the front coupling groove 414a. The light source part 415 may be placed on the rear surface of the first front extension part 4142. For example, the light source part 415 may be attached to the rear surface of the first front extension part 4142 through an adhesive member.

The front restraint part 4144 may be formed to protrude downward from the front end of the front base member 4141. For example, the front restraint part 4144 may be provided in a hook shape.

A plurality of front restraint parts 4144 may be provided. The plurality of front restraint parts 4144 may be disposed spaced apart from each other along the extension direction of the front base part 4141. A separation space 4144a may be formed between adjacent front restraint parts 4144.

Meanwhile, the front fastening hole 4141h may be disposed between adjacent front restraint parts 4144. The front fastening hole 4141h may be connected to a separation space 4144a. Therefore, when the front coupling member 414 is fixed to the upper part 111 of the inner case 11 using a fastening member inserted into the front fastening hole 4141h, the fastening member may enter through the separation space 4144a and be fastened.

The front coupling member 414 may include a front mounting groove 414b defined by a front base part 4141, a first front extension part 4142, and a front restraint part 4144. The front mounting groove 414b may be defined by a lower surface of the front base part 4141, a front surface of the first front extension part 4142, and a rear surface of the front restraint part 4144.

At least a part of a cover member 43 mounted on a front coupling member 414 can be placed in the front mounting groove 414b. For example, the cover member 43 can be mounted on the front coupling member 414 by being hooked to a front restraint part 4144.

The mounting structure between the front restraint 4144 and the cover member 43 will be described later with reference to FIG. 17.

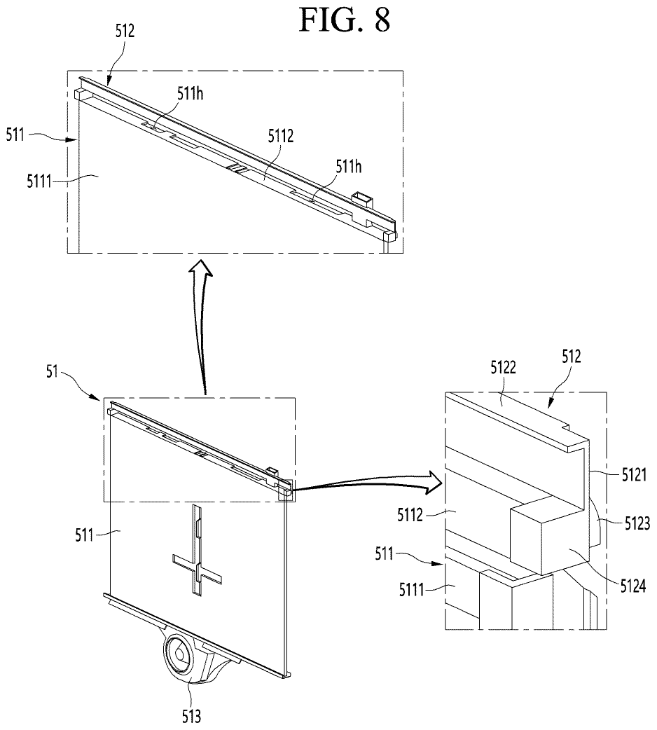

Below, the detailed structure of the duct member 51 will be described with reference to FIG. 8.

FIG. 8 is a perspective view illustrating a duct member according to one embodiment.

Referring to FIG. 8, as described above, the duct member 51 may include a duct plate part 511, a duct guide part 512 disposed on the upper side of the duct plate part 511, and a duct fan 513 disposed on the lower side of the duct plate part 511.

The duct plate part 511 may include a duct front part 5111 positioned toward the front and a duct upper part 5112 positioned toward the top.

The duct front part 5111 may be disposed toward the first storage compartment 10a. The duct front part 5111 may have a flat plate shape. The duct front part 5111 may form a main surface of the duct plate part 511. Cold air guided by the duct member 51 may flow at the rear of the duct front part 5111.

The duct upper part 5112 may be disposed toward the upper part 111 of the inner case 11. The duct upper part 5112 may be connected to the upper end of the duct front surface 5111. The duct upper part 5112 may have a shape extending rearward from the upper end of the duct front surface 5111.

For example, the duct upper part 5112 may include a cold air discharge port 511h for discharging cold air. In other words, cold air flowing upward from the rear of the duct front part 5111 by the duct fan 513 may be discharged through the cold air discharge port 511h formed in the duct upper part 5112 and may move toward the first storage compartment 10a. A plurality of cold air discharge ports 511h may be provided and disposed along the extension direction of the duct upper part 5112.

Meanwhile, the duct guide part 512 can guide the cold air discharged through the cold air discharge port 511h forward. As described above, since the cold air discharge port 511h is formed on the duct upper part 5112, the cold air discharged through the cold air discharge port 511h can be discharged upward. Accordingly, the cold air discharged from the cold air discharge port 511h can be guided toward the first storage compartment 10a by the duct guide part 512.

The duct guide part 512 can be placed on the upper side of the duct plate part 511. The duct guide part 512 can be connected to the duct upper part 5112.

The duct guide part 512 may include a guide base part 5121 positioned on the upper part of the duct upper part 5112, a guide rib 5122 extending forward from the upper end of the guide base part 5121, a guide round part 5123 positioned on the lower part of the guide base part 5121, and a guide support part 5124 positioned on both side end parts of the guide base part 5121.

The guide base part 5121 can be disposed toward the first storage compartment 10a. The guide base part 5121 can extend in the same direction as the extension direction of the duct upper part 5112. When the lighting device 41 is mounted, the guide base part 5121 can be disposed opposite the rear base part 4121. In other words, the guide base part 5121 can support the rear base part 4121 of the lighting device 41.

The guide rib 5122 may be formed to extend from the upper end of the guide base part 5121 toward the first storage compartment 10a. The guide rib 5122 may be disposed facing the upper part 111 of the inner case 11.

The guide round part 5123 can be connected to the lower end part of the guide base part 5121. The guide round part 5123 can extend downwardly and rearwardly from the lower end part of the guide base part 5121. The guide round part 5123 can have a shape that becomes rounder toward the rear as it goes downward. In other words, the guide round part 5123 can have a shape that becomes rounder toward the rear as it goes downward.

The guide round part 5123 can guide the cold air discharged from the cold air discharge port 511h forward. The cold air discharged from the cold air discharge port 511h can be discharged upward and moved toward the first storage compartment 10a by the guide round part 5123.

Guide support parts 5124 may be disposed on both sides of the guide base part 5121. In other words, the guide support parts 5124 may be disposed on one side and the other side of the guide base part 5121, respectively. For example, the guide support parts 5124 may be disposed on the lower part of one side end part of the guide base part 5121 and the lower part of the other side end.

Meanwhile, the guide support part 5124 may be disposed on both sides of the duct upper part 5112. The guide support part 5124 may be disposed on one side and the other side of the duct upper part 5112, respectively. For example, the guide support part 5124 may have a shape that is stepped upward from the duct upper part 5112.

The rear end of the lighting device 41 can be mounted on the guide support part 5124. In other words, the guide support part 5124 can support the rear end of the lighting device 41. The rear coupling member 412 of the lighting device 41 can be seated on the guide support part 5124. For example, the guide support part 5124 can include a flat upper surface so as to support the rear end of the lighting device 41.

FIG. 9 is a cross-sectional perspective view taken along line 9-9 of FIG. 3. Specifically, FIG. 9 is a view for explaining the mounting structure of the upper lighting assembly 40 and the inner case 11.

Referring to FIG. 9, the inner case 11 may include an upper part 111 forming an upper surface and a rear part 112 forming a rear surface.

An upper lighting assembly 40 according to one embodiment may be mounted on an upper part 111 of an inner case 11. The upper lighting assembly 40 may be positioned on a lower surface of the upper part 111 of the inner case 11. The upper lighting assembly 40 may be fixed to the upper part 111 of the inner case 11 through a fastening assembly 80.

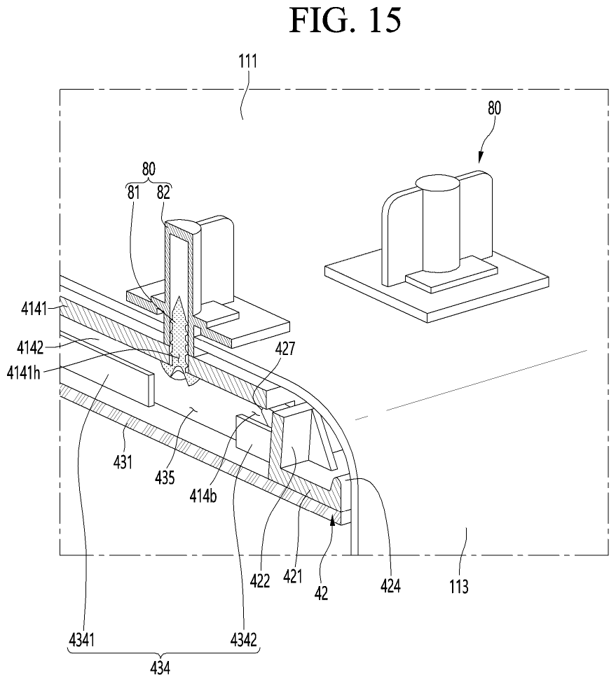

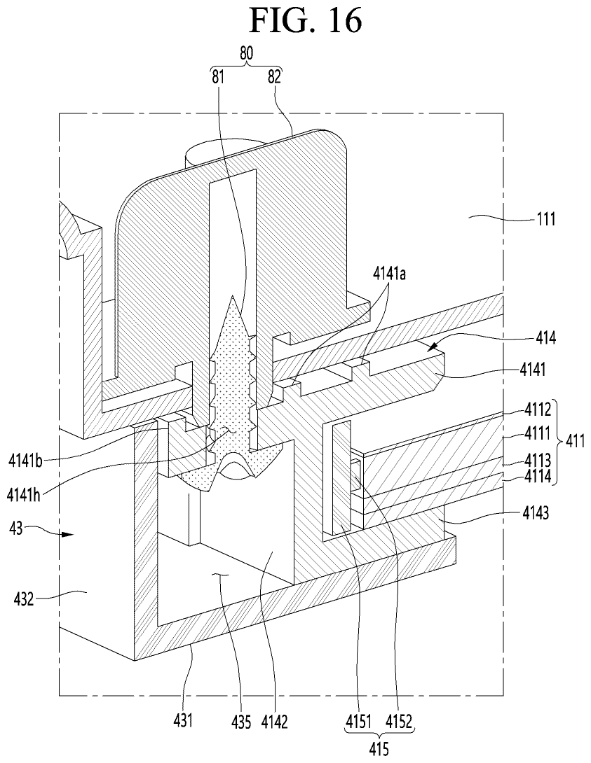

The lighting device 41 can be mounted on the upper part 111 of the inner case 11. For example, the lighting device 41 can be fixed to the upper part 111 of the inner case 11 through a fastening assembly 80. The fixing structure of the lighting device 41 to the upper part 111 of the inner case 11 will be described later with reference to FIGS. 15 to 17.

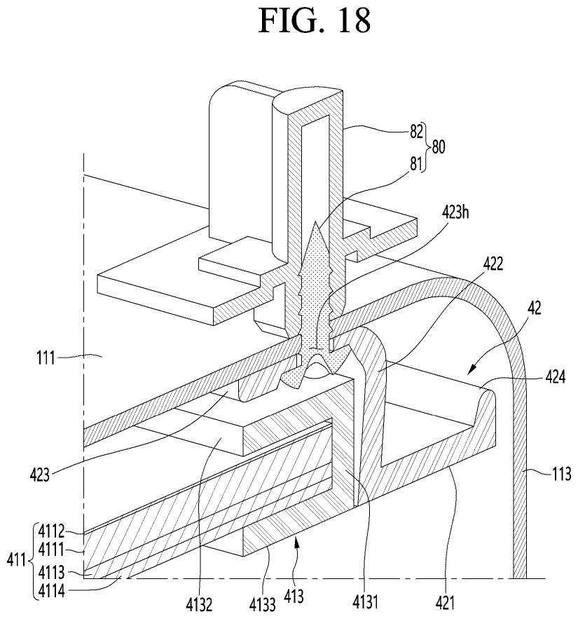

The support member 42 is placed on both sides of the lighting device 41 and can be fixed to the upper part 111 of the inner case 11 through the fastening assembly 80. The fixing structure of the support member 42 to the upper part 111 of the inner case 11 will be described later with reference to FIG. 18.

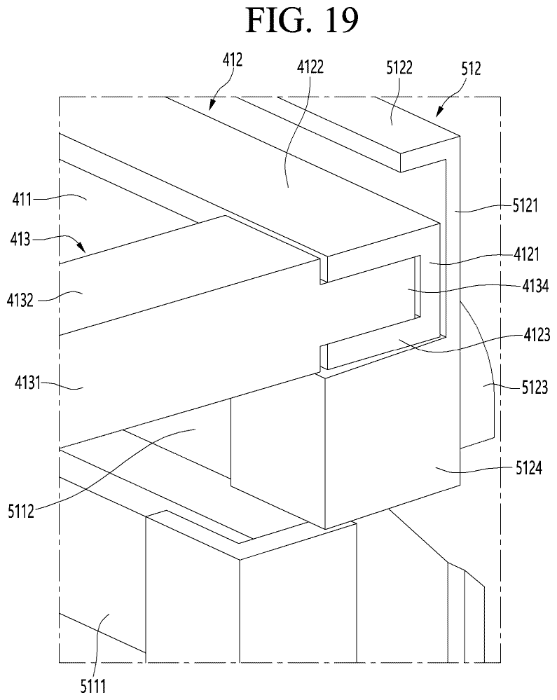

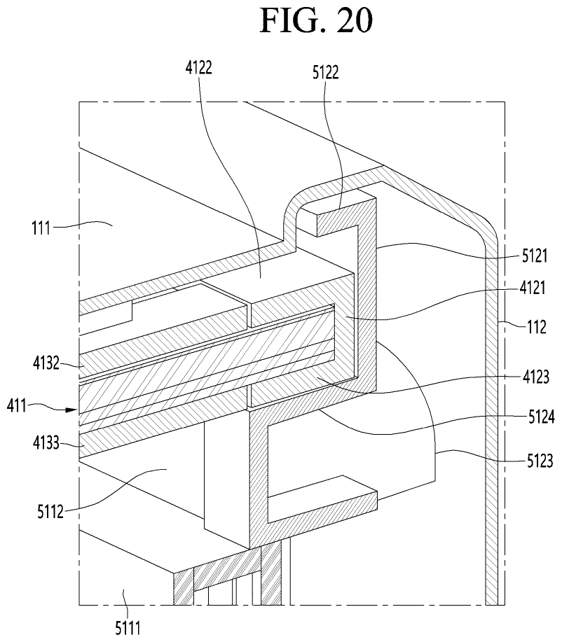

Meanwhile, a duct assembly 50 may be disposed in front of the rear part 112 of the inner case 11. The rear end of the upper lighting assembly 40 may be supported by the duct assembly 50. For example, the rear end of the lighting device 41 may be supported by the guide support part 5124 of the duct guide part 512. The structure in which the rear end of the upper lighting assembly 40 is supported by the duct assembly 50 will be described later with reference to FIGS. 19 and 20.

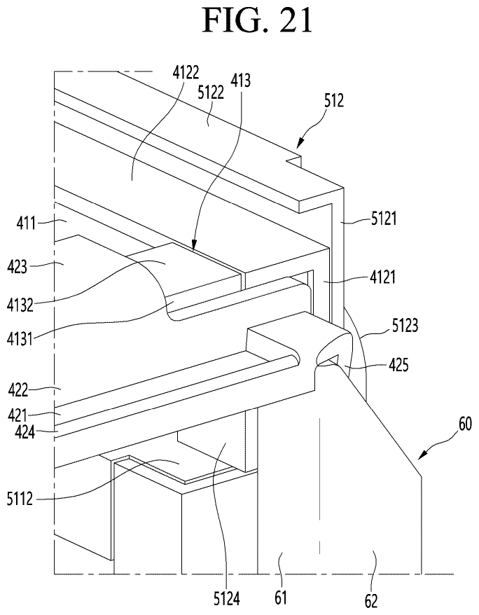

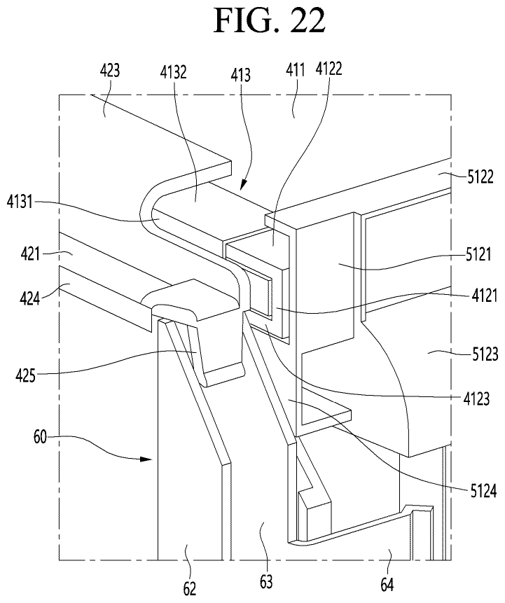

A shelf mounting member 60 may be disposed on both sides of the duct assembly 50. The shelf mounting member 60 may support the support member 42. For example, the rear end of the support member 42 may be supported by the shelf mounting member 60. The rear end of the support member 42 may be hooked and coupled to the upper end of the shelf mounting member 60. The structure in which the rear end of the support member 42 is supported by the shelf mounting member 60 will be described later with reference to FIGS. 21 and 22.

First, before explaining the detailed mounting structure of the upper lighting assembly 40, the detailed structures of the support member 42, the cover member 43, and the shelf mounting member 60 will be explained with reference to FIGS. 10 to 14.

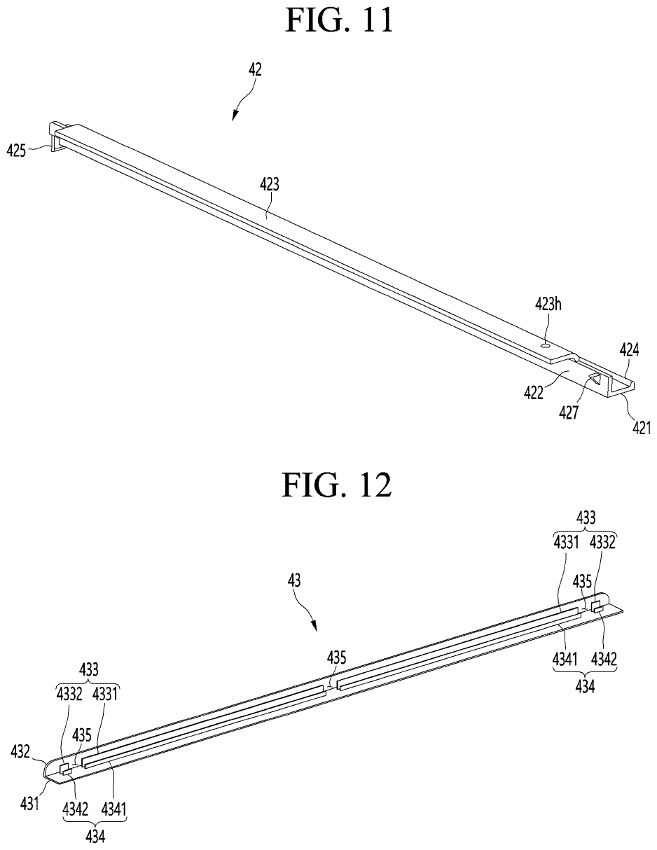

FIGS. 10 and 11 are perspective views illustrating a support member according to one embodiment.

Referring to FIGS. 10 and 11, a support member 42 according to one embodiment may include a support base part 421 extending in one direction, a support side part 422 extending upwardly and bent from an inner end part of the support base part 421, a support fastening part 423 extending inwardly from an upper end of the support side part 422, and a support hook part 425 formed at a rear end of the support base part 421.

The support base part 421 may have a shape that extends in the front and rear direction. The support base part 421 may extend in the same direction as the extension direction of the side coupling member 413. A support side part 422 may be disposed at one end in a direction intersecting the extension direction of the support base part 421.

The support side part 422 may be formed by being bent from the inner end part of the support base part 421. The support side part 422 may extend in the same direction as the extension direction of the support base part 421. The support side part 422 may be disposed to face the side end part of the lighting device 41. For example, the support side part 422 may support the side end part of the lighting device 41. The support side part 422 may support the side coupling member 413 of the lighting device 41. The upper end of the support side part 422 may be connected to the support fastening part 423.

The support fastening part 423 may have a shape extending inward from the upper end of the support side part 422. The support fastening part 423 may extend in the same direction as the direction in which the support side part 422 extends.

The support fastening part 423 may be a part that is fixed to the upper part 111 of the inner case 11 in the support member 42. The support fastening part 423 may include a support fastening hole 423h. A fastening assembly 80 for fixing the support member 42 to the upper part 111 of the inner case 11 may be inserted into the support fastening hole 423h. For example, the support fastening hole 423h may be located closer to the front end than the rear end of the support fastening part 423.

The support hook part 425 may be formed at the rear end of the support base part 421. The support hook part 425 may be formed by being bent downward at the rear end of the support base part 421. The support hook part 425 may be hooked and coupled to the upper end of the shelf mounting member 60. Accordingly, the rear end of the support member 42 may be hooked and coupled to the shelf mounting member 60 by the support hook part 425, and the front end of the support member 42 may be fixed to the upper part 111 of the inner case 11 through the fastening assembly 80 penetrating the support fastening hole 423h.

The support member 42 according to one embodiment may further include a support protrusion part 424 formed at an outer end of the support base part 421. For example, the support protrusion part 424 may be supported on an inner surface of the inner case 11. The support protrusion part 424 may be formed to protrude upward from the outer end of the support base part 421. The support protrusion part 424 may be formed on an opposite side of the support side part 422. In other words, the support side part 422 may be disposed at one end of the support base part 421, and the support protrusion part 424 may be disposed at the other end of the support base part 421. The support protrusion part 424 may be formed to protrude in the same direction as the extension direction of the support side part 422.

The support member 42 according to one embodiment may further include a reinforcing rib 426. The reinforcing rib 426 may structurally reinforce the support member 42. The reinforcing rib 426 may be disposed across the support base part 421 and the support side part 422. For example, the reinforcing rib 426 may be disposed across the upper surface of the support base part 421 and the outer surface of the support side part 422.

The support member 42 according to one embodiment may further include a support protrusion 427 disposed on the inner surface of the support side part 422. The support protrusion 427 may be disposed close to the front end of the support side part 422. The support protrusion 427 may be formed to protrude toward the lighting device 41 on the inner surface of the support side part 422. The support protrusion 427 may be formed on the opposite surface of the surface on which the reinforcing rib 426 is disposed in the support side part 422. In other words, the reinforcing rib 426 may be disposed on one surface of the support side part 422, and the support protrusion 427 may be disposed on the other surface.

FIG. 12 is a perspective view illustrating a cover member according to one embodiment.

A cover member 43 according to one embodiment may include a cover base part 431 extending in one direction, a cover front part 432 formed by bending from a front end of the cover base part 431, a cover coupling part 433 formed by protruding upward from the cover base part 431, and a cover support part 434.

The cover base part 431 may have a shape extending in one direction. The cover base part 431 may support the front end of the lighting device 41 from the lower side. The cover base part 431 may have a shape corresponding to the front end of the lighting device 41.

The cover front part 432 may be formed by being bent upward from the front end of the cover base part 431. The cover front part 432 may shield the front end of the lighting device 41 to prevent exposure of the lighting device 41. The cover front part 432 may be a part that is visible when viewed from the front of the first storage compartment 10a.

The cover coupling part 433 can be positioned spaced from the rear of the cover front part 432. The cover coupling part 433 can be hooked and coupled with the front restraint part 4144 of the front coupling member 414. In addition, the cover coupling part 433 can structurally reinforce the cover member 43.

The cover coupling part 433 may include a first cover coupling part 4331 extending in one direction and a second cover coupling part 4332 positioned spaced apart from the first cover coupling part 4331. The second cover coupling part 4332 may be positioned at both side ends of the cover base part 431, and the first cover coupling part 4331 may be positioned on the inner side of a pair of second cover coupling parts 4332. The first cover coupling part 4331 may be provided in a plurality spaced apart from each other.

A cut-out 435 may be formed between the first cover coupling part 4332 and the second cover coupling part 4332. In addition, a cut-out 435 may be formed between a pair of first cover coupling parts 4331. The cut-out 435 may form a refuge space in which the fastening assembly 80 is placed. Accordingly, even if the cover member 43 is mounted on the lighting device 41, the fastening assembly 80 and the cover member 43 may not interfere with each other.

The cover support part 434 may be disposed spaced apart from the rear of the cover coupling part 433. The cover support part 434 may be disposed in an area corresponding to the cover coupling part 433. In other words, the cover support part 434 may be disposed to overlap the cover coupling part 433 in the front and rear direction. For example, the protruding height of the cover support part 434 may be smaller than the protruding height of the cover coupling part 433. The cover support part 434 may be disposed facing the front end of the lighting device 41. The cover support part 434 may support the front end of the lighting device 41.

The cover support part 434 may include a first cover support part 4341 that extends in one direction and is positioned at the rear of the first cover coupling part 4331, and a second cover support part 4342 that is positioned spaced apart from the first cover support part 4341 and is positioned at the rear of the second cover coupling part 4332. The cut-out 435 is positioned between the first cover support part 4341 and the second cover support part 4342, and may also be positioned between a pair of first cover support members 4341.

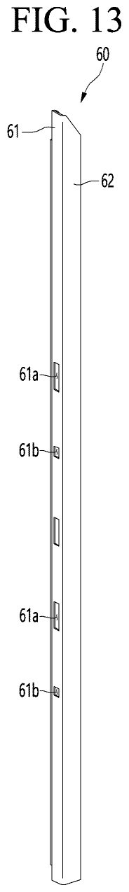

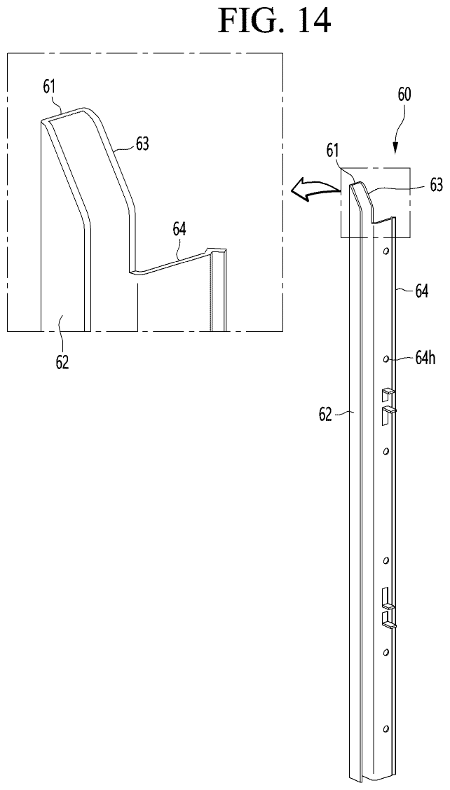

FIGS. 13 and 14 are perspective views illustrating a shelf mounting member according to one embodiment.

Referring to FIGS. 13 and 14, a shelf mounting member 60 according to one embodiment may include a shelf mounting front part 61 extending in one direction, a first shelf mounting side part 62 bent from one end of the shelf mounting front part 61, a second shelf mounting side part 63 bent from the other end of the shelf mounting front part 61, and a shelf mounting fixing part 64 bent outward from the rear end of the second shelf mounting side part 63.

The shelf mounting front part 61 may have a shape extending in the vertical direction. A support hook part 425 of a support member 42 may be hooked and coupled to the upper end of the shelf mounting front part 61.

The shelf mounting front part 61 may include open shelf mounting holes 61a, 61b. At least a part of a shelf member 71 may be inserted and mounted into the shelf mounting holes 61a, 61b. The shelf mounting holes 61a, 61b may include a first shelf mounting hole 61a positioned at the upper part and a second shelf mounting hole 61b positioned at the lower part. For example, one shelf member 71 may be inserted and mounted into both the first shelf mounting hole 61a and the second shelf mounting hole 61b.

The first shelf mounting side part 62 and the second shelf mounting side part 63 can extend in the same direction as the extension direction of the shelf mounting front part 61. The first shelf mounting side part 62 and the second shelf mounting side part 63 can be disposed to face each other. The first shelf mounting side part 62 can be disposed to face the side part ‘113’ (FIG. 15) of the inner case 11. The second shelf mounting side part 63 can be disposed to face the guide support part 5124 of the duct guide part 512. The second shelf mounting side part 63 can be supported by the guide support part 5124.

The shelf mounting fixing part 64 may be formed to extend outwardly from the second shelf mounting side part 63. The shelf mounting fixing part 64 may be disposed at the rear of the duct plate part 511. The shelf mounting fixing part 64 may include an open shelf mounting fixing hole 64h. The shelf mounting fixing part 64 may be fixed to the duct plate part 511 through a fastening part penetrating the shelf mounting fixing hole 64h.

Below, the mounting structure of the upper lighting assembly 40 will be described in detail with reference to FIGS. 15 to 22 together with FIG. 9.

Referring to FIGS. 15 to 17 together with FIG. 9, the fastening assembly 80 may include a fastening member 81 and a boss member 82 to which the fastening member 81 is fastened. For example, the fastening member 81 may be a bolt, and the boss member 82 may be configured to which the fastening member 81 is fastened. The boss member 82 may be disposed on an outer surface of the inner case 11. For example, the boss member 82 may be disposed on an upper surface of an upper part 111 of the inner case 11.

The fastening member 81 can be inserted into the front fastening hole 4141h of the front base part 4141 and fastened by penetrating the upper part 111 of the inner case 11. The fastening member 81 fastened to the front fastening hole 4141h may not interfere with the cover member 43 due to the cut-out 435 formed between the first cover support part 4341 and the second cover support part 4342.

The support base part 421 of the support member 42 can support the cover base part 431.

In addition, the support side part 422 of the support member 42 can support both side ends of the front coupling member 414. The support side part 422 of the support member 42 can support both side ends of the second cover coupling part 4332 and both side ends of the second cover support part 4342, respectively. Accordingly, the support member 42 can support the lighting device 41 on both left and right sides, thereby preventing the lighting device 41 from moving in the left and right direction.

The support projection 427 of the support member 42 can be inserted into the front mounting groove 414b of the front coupling member 414. The support projection 427 inserted into the front mounting groove 414b can support the first front extension part 4142. In other words, the support member 42 can support the lighting device 41 backward. Accordingly, the support member 42 can prevent movement of the lighting device 41 in the front and rear direction.

Meanwhile, the light guide assembly 411 may include a light guide member 4111, a reflective member 4112 disposed on one surface of the light guide member 4111, a diffusion member 4113 disposed on the other surface of the light guide member 4111, and a film member 4114 disposed on the diffusion member 4113. The light guide assembly 411 may be seated on the second front extension part 4143.

The light guide member 4111 can serve to guide light by diffusing or scattering light. Light provided from the light source part 415 can be irradiated toward the front end of the light guide member 4111. For example, the light guide member 4111 can be formed of a polymer material such as PMMA.

The reflective member 4112 can serve to reflect light emitted toward the upper surface of the light guide member 4111 toward the lower surface of the light guide member 4111. Accordingly, the reflective member 4112 can allow light to be emitted as much as possible downward from the upper lighting assembly 40, thereby minimizing light loss as much as possible.

A filling member 91 may be placed between the reflective member 4112 and the front base part 4141. The filling member 91 may fill the space between the reflective member 4112 and the front base part 4141 to support the light guide assembly 411. In other words, the light guide assembly 411 may be fixed in position through the filling member 91. For example, the filling member 91 may be provided as foam or sponge.

The diffusion member 4113 can serve to diffuse the light emitted through the light guide member 4111 downward as evenly as possible. Accordingly, the diffusion member 4113 can improve the light clarity and light uniformity of the upper lighting assembly 40.

The film member 4114 can form the outer appearance of the lower surface of the light guide assembly 411. The film member 4114 can be a finishing member that forms the upper surface design of the first storage compartment 10a that is visible to the user when the upper lighting assembly 40 is turned off.

The light source part 415 may include a light source substrate 4151 and a light source element 4152 disposed on the light source substrate 4151.

The light source substrate 4151 can be attached to the rear surface of the first front extension part 4142 of the front coupling member 414. The light source substrate 4151 can extend along the front end of the light guide assembly 411.

The light source element 4152 may be placed on the light source substrate 4151. The light source element 4152 is a light-emitting element and may provide light. Light provided from the light source element 4152 may be irradiated toward the light guide member 4111. Although not illustrated, a plurality of light source elements 4152 may be provided. The plurality of light source elements 4152 may be arranged along the extension direction of the light source substrate 4151. As an example, the light source element 4151 may be an LED (Light Emitting Diode) element.

Meanwhile, the light source element 4152 may be connected to a power supply part 90 that supplies power. For example, an electric wire connecting the light source element 4152 and the power supply part 90 may be placed between the filling member 91 and the front base part 4141, or may be placed by penetrating the filling member 91.

The cover support part 434 of the cover member 43 can support the lighting device 41. For example, the cover support part 434 of the cover member 43 can support the first front extension member 4142 of the front coupling member 414.

The front restraint part 4144 can be hooked and coupled to the cover coupling part 433. Since the front restraint part 4144 is hooked and coupled to the cover coupling part 433, the cover member 43 can be mounted to the lighting device 41. Accordingly, the cover member 43 can prevent the lighting device 41 from being exposed to the front.

FIG. 18 is a cross-sectional view taken along line 18-18 of FIG. 9.

Referring to FIG. 18 together with FIG. 9, the front end of the support member 42 can be fixed to the upper part 111 of the inner case 11 by the fastening assembly 80. The fastening member 81 can be inserted into the support fastening hole 423h of the support fastening part 423 and penetrate the upper part 111 of the inner case 11.

The support fastening part 423 of the support member 42 can be disposed spaced apart from the side coupling member 413. The support fastening part 423 can be disposed spaced apart from the first side extension part 4132. Through the above structure, the fastening member 81 can be prevented from interfering with the lighting device 41.

The supporting side part 422 of the supporting member 42 can support both side ends of the lighting device 41. For example, the supporting side part 422 can support the side base part 4131 of the side coupling member 413. Through the above structure, the supporting member 42 can prevent left-right movement of the lighting device 41.

FIG. 19 is a cross-sectional view taken along line 19-19 of FIG. 9. FIG. 20 is a cross-sectional view taken along line 20-20 of FIG. 9.

Referring to FIGS. 19 and 20 along with FIG. 9, the rear end of the lighting device 41 may be supported by the duct guide member 512. For example, the rear end of the lighting device 41 may be supported by being seated on the guide support part 5124. In other words, the guide support part 5124 may support both sides of the rear end of the lighting device 41.

The guide support part 5124 can support the rear coupling member 412. For example, the guide support part 5124 can support both ends of the rear coupling member 412. An area of the rear coupling member 412 other than a part supported by the guide support part 5124 can be disposed to be spaced apart from the duct upper part 5112. Accordingly, the cold air discharged from the cold air discharge port 511h can smoothly move toward the first storage compartment 10a.

FIGS. 21 and 22 are perspective views illustrating enlarged views of area A of FIG. 9.

Referring to FIGS. 21 and 22 along with FIG. 9, the rear end of the support member 42 can be hooked and coupled to the upper end of the shelf mounting member 60. For example, the support hook part 425 of the support member 42 can be hooked and coupled to the upper end of the shelf mounting front part 61.

In a state where the rear end of the support member 42 is hooked and coupled to the upper end of the shelf mounting member 60, the support member 42 can support both side ends of the lighting device 41. For example, the support side part 422 of the support member 42 can support the side coupling member 413 of the lighting device 41. In addition, the support side part 422 of the support member 42 can support both side ends of the rear coupling member 412 of the lighting device 41. Through the above structure, the support member 42 can support the lighting device 41 at both side ends, thereby preventing left-right movement of the lighting device 41.

According to a refrigerator 1 according to one embodiment, the rear end of the lighting device 41 is supported by the duct guide part 512, and the front end thereof is fixed by being fastened to the upper part 111 of the inner case 11, so that the lighting device 41 can be stably fixed to the upper surface of the first storage compartment 10a.

Meanwhile, the rear end of the support member 42 is hooked and coupled to the upper end of the shelf mounting member 60, and the front end thereof is fixed by being fastened to the upper part 111 of the inner case 11, so that the support member 42 can be stably fixed to one side and the other side of the lighting device 41, respectively.

In addition, the support member 42 can prevent left-right movement of the lighting device 41 through a structure that supports both sides of the lighting device 41.

In addition, the cover member 43 has a structure in which it is hooked and coupled to the front coupling member 414, thereby preventing the lighting device 41 from being seen from the front, thereby improving the aesthetics of the upper lighting assembly 40.

In addition, the cover member 43 can structurally prevent the fastening member 81 that fixes the front fastening member 414 to the upper part 111 of the inner case 11 from interfering with the cover member 43 through the cut-out 435 structure where the cover coupling part 433 and the cover coupling part 434 are not disposed.

Meanwhile, the present disclosure may have various other embodiments in addition to the above-described embodiments. Hereinafter, other embodiments of the present disclosure will be described with reference to the drawings. Among the configurations of other embodiments, the same configurations as those of the above-described embodiments may be omitted from description and illustration, and may be described using the same drawing reference numerals. In other words, only the structures that are different from those of the above-described embodiments will be described below, and other configurations that are not described may be the same as those of the above-described embodiments.

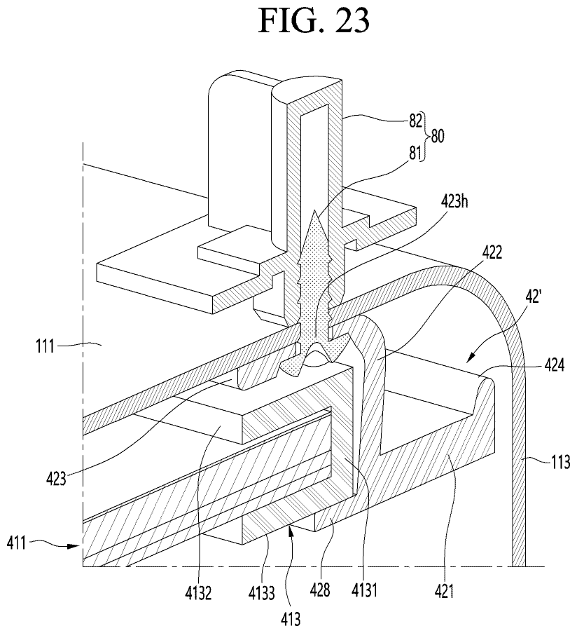

FIG. 23 is a cross-sectional view taken along line 18-18 of FIG. 9 of a refrigerator according to another embodiment.

Referring to FIG. 23, the support member 42′ according to the present embodiment is structurally different from the support member 42 according to one embodiment in that it includes a support rib 428 that protrudes inwardly from the support base part 421.

The support member 42′ according to the present embodiment may further include a support rib 428 that protrudes and extends from the support base part 421 toward the side coupling member 413. For example, the support rib 428 may extend along the extension direction of the support base part 421.

The support rib 428 can support the lighting device 41. For example, the support rib 428 can support both side ends of the lighting device 41. The support rib 428 can support the side coupling member 413. In other words, both side ends of the lighting device 41 can be seated on the support rib 428. The side coupling member 413 of the lighting device 41 can be seated on the support rib 428.

Meanwhile, in another embodiment, the support member 42′ and the side coupling member 413 may be formed integrally. For example, the side coupling member 413 may be formed integrally with the support member 42′ and may be formed as a part of the support member 42′.

The support member 42′ according to the present embodiment can temporarily fix the position of the lighting device 41 before fixing the lighting device 41 to the upper part 111 of the inner case 11 via the support rib 428. In other words, after the worker places the lighting device 41 on the support rib 428 of the support member 42′, the worker can fix the front coupling member 414 of the lighting device 41 to the upper part 111 of the inner case 11 via the fastening assembly 80 as illustrated in FIGS. 16 and 17.

According to the refrigerator 1 according to the present embodiment, the rear end of the lighting device 41 is supported by the duct guide part 512, and the front end is fixed by being fastened to the upper part 111 of the inner case 11, so that the lighting device 41 can be stably fixed to the upper surface of the first storage compartment 10a.

Meanwhile, the rear end of the support member 42′ is hooked and coupled to the upper end of the shelf mounting member 60, and the front end thereof is fixed by being fastened to the upper part 111 of the inner case 11, so that the support member 42′ can be stably fixed to one side and the other side of the lighting device 41, respectively.

In addition, the support member 42′ can prevent left-right movement of the lighting device 41 through a structure that supports both sides of the lighting device 41.

In addition, the cover member 43 has a structure in which it is hooked and coupled to the front coupling member 414, thereby preventing the lighting device 41 from being seen from the front, thereby improving the aesthetics of the upper lighting assembly 40.

In addition, the cover member 43 can structurally prevent the fastening member 81 that fixes the front fastening part 414 to the upper part 111 of the inner case 11 from interfering with the cover member 43 through the cut-out 435 structure where the cover coupling part 433 and the cover coupling part 434 are not disposed.

In addition, in the process of fixing the upper lighting assembly 40 to the inner case 11, the lighting device 41 is configured to be seated on the support rib 428 of the support member 42′ and then fastened, so that the assembly workability can be improved.

What is claimed is:

1. A refrigerator comprising:
a cabinet forming a storage compartment;
a lighting assembly disposed at an inner upper part of the storage compartment and providing light toward the storage compartment; and
a duct assembly disposed at an inner rear part of the storage compartment,
wherein the lighting assembly includes a lighting device having a rear end which is supported by the duct assembly and a front end which is fixed to the cabinet.

2. The refrigerator of claim 1, wherein the lighting device includes:
a light guide assembly in a shape of a flat plate,
a light source part irradiating light toward one side of the light guide assembly, and
a coupling member coupled along a perimeter of the light guide assembly.

3. The refrigerator of claim 2, wherein the coupling member includes:
a rear coupling member coupled to a rear end part of the light guide assembly and supported by the duct assembly, and
a front coupling member coupled to a front end part of the light guide assembly and fixed to the cabinet.

4. The refrigerator of claim 3, wherein the lighting assembly further includes a cover member that is mounted on the front coupling member and shields the front end of the lighting device.

5. The refrigerator of claim 4, wherein the front coupling member includes:
a front base part that extends in an extension direction of the front end part of the light guide assembly and faces an upper surface of the front end part of the light guide assembly,
a front extension part that extends downward from one surface of the front base part and faces a side surface and a lower surface of the front end part of the light guide assembly, and
a front restraint part that is formed by protruding downward from a front end of the front base part.

6. The refrigerator of claim 5, wherein the cover member includes:
a cover base part extending in an extension direction of the front base part,
a cover front part bent upward from a front end of the cover base part, and
a cover coupling part formed by protruding upward from one surface of the cover base part, and
wherein the cover coupling part is hooked and coupled to the front restraint part.

7. The refrigerator of claim 6, wherein the front base part is fixed to the cabinet through a fastening part and includes a fastening hole through which the fastening part penetrates, and
wherein the cover coupling part extends in the extension direction of the cover base part and includes a cut-out formed at a position corresponding to the fastening hole.

8. The refrigerator of claim 3, wherein the coupling member further includes a side coupling member coupled to both side end parts of the light guide assembly, and
wherein a rear end part of the side coupling member is fitted to both end parts of the rear coupling member.

9. The refrigerator of claim 3, wherein the front coupling member forms a space in which the light source part is accommodated.

10. The refrigerator of claim 3, wherein the front coupling member is fixed to the cabinet through a fastening part.

11. The refrigerator of claim 1, further comprising:
a shelf provided inside the storage compartment; and
a shelf mounting member on which the shelf is detachably mounted and which is provided on one side and the other side of the duct assembly,
wherein the lighting assembly further includes a supporting member supporting both side ends of the lighting device,
wherein a rear end of the supporting member is supported by an upper end of the shelf mounting member, and
wherein a front end of the supporting member is fixed to the cabinet.

12. The refrigerator of claim 11, wherein the support member includes:
a support base part extending in an extension direction of a side end part of the lighting device, and
a support hook part formed at a rear end of the support base part and hooked and coupled to the upper end of the shelf mounting member.

13. The refrigerator of claim 12, wherein the support member further includes a support side part that extends upwardly from an inner end part of the support base part and supports both side ends of the lighting device, and a support fastening part that extends inwardly from an upper end of the support side part and is fixed to the cabinet.

14. The refrigerator of claim 13, wherein the support fastening part is disposed spaced apart from the lighting device in a vertical direction.

15. The refrigerator of claim 13, wherein the support member is formed by protruding inwardly from the support base part, and further includes a support rib that supports both side ends of the lighting device.

16. The refrigerator of claim 13, wherein the lighting device includes:
a flat-plate shaped light guide assembly,
a front coupling member coupled to a front end of the flat-plate shaped light guide assembly,
wherein the support member further includes a support protrusion formed on an inner surface of the support side part and protruding toward the front coupling member, and
wherein the front coupling member includes a front mounting groove in which the support protrusion is disposed.

17. The refrigerator of claim 1, wherein the duct assembly includes:
a duct plate including a duct front part defining a rear surface of the storage compartment, and a duct upper part including a cold air discharge port through which cold air is discharged, and
a duct guide part disposed on an upper part of the duct plate and guiding cold air discharged from the cold air discharge port to be discharged toward the storage compartment, and
wherein the rear end of the lighting device is supported by the duct guide part.

18. The refrigerator of claim 17, wherein the duct guide part includes:
a guide base part that is disposed on an upper part of the duct upper part and is disposed toward the storage compartment,
a guide round part that is connected to a lower end part of the guide base part and is rounded downward as the guide round part extends rearward, and
a guide support part that is disposed on both side end parts of the guide base part, and
wherein the rear end of the lighting device is supported by the guide support part.

19. The refrigerator of claim 18, wherein the lighting device includes:
a flat plate-shaped light guide assembly, and
a rear coupling member coupled to a rear end of the flat plate-shaped light guide assembly, and
wherein the guide support part supports both side end parts of the rear coupling member.

20. The refrigerator of claim 1, wherein the cabinet includes:
an inner case forming the storage compartment,
an outer case forming an outer appearance and disposed outside the inner case, and
an insulation material disposed between the inner case and the outer case, and
wherein the front end of the lighting device is fixed to an upper part of the inner case forming an upper surface of the storage compartment.
